(19) United States
(12) Patent Application Publication
(10) Pub. No.: US 2008/0187831 A1
(43) Pub. Date: Aug. 7, 2008

(54) Oxynitride-Based Electrode Active Materials For Secondary Electrochemical Cells

(75) Inventor: Jeremy Barker, Shipton-Under-Wychwood (GB)

Correspondence Address: VALENCE TECHNOLOGY, INC., 1889 E. MAULE AVENUE, SUITE A, LAS VEGAS, NV, 89119, US

(73) Assignee: Valence Technology, Inc.

(21) Appl. No.: 12/027,220

(22) Filed: Feb. 6, 2008

Related U.S. Application Data
(60) Provisional application No. 60/888,732, filed on Feb. 7, 2007.

(51) Int. Cl. H01M 4/48; H01M 4/50; H01M 4/52; H01M 4/56; H01M 10/36

(52) U.S. Cl. 429/188; 429/231.5; 429/231.9; 429/224; 429/221; 429/223; 429/220; 429/225; 429/231.8

(57) ABSTRACT

The invention provides an electrochemical cell which includes a first electrode having a electrode active material, a second electrode which is a counter electrode to the first electrode, and an electrolyte. The positive electrode active material is represented by the general formula AₐM_{b}X_{c}[O_{(3c+1)-d},Nₑ].

This application claims the benefit of Provisional application Ser. No. 60/888,732 filed Feb. 7, 2007.

### FIELD OF THE INVENTION

This invention relates to an electrochemical cell, and more particularly to a secondary electrochemical cell employing an oxynitride-based electrode active material.

### BACKGROUND OF THE INVENTION

A battery pack consists of one or more electrochemical cells or batteries, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

### SUMMARY OF THE INVENTION

The present invention provides a novel secondary electrochemical cell employing an oxy-nitride electrode active material represented by the general formula:

AₐM_{b}X_{c}[O_{(3c+1)-d},Nₑ]

wherein:
(a) A is at least one alkali metal, and 0<a≦6;
(b) M is at least one redox active element, wherein 1≦b≦4;
(c) X is selected from the group consisting of P, As, Sb, Si, Ge, V, S, and mixtures thereof; and
(d) 2≦c≦5, 0<d≦(3c+1), and 0<e≦d; and
wherein A, M, X, a, b, c, d and e are selected so as to maintain electroneutrality of the material in its nascent or “as-synthesized” state.

The secondary electrochemical cell includes an electrode assembly enclosed in a casing. The electrode assembly includes a separator interposed between a first electrode (positive electrode) and a counter second electrode (negative electrode), for electrically insulating the first electrode from the second electrode. An electrolyte (preferably a non-aqueous electrolyte) is provided for transferring ionic charge carriers between the first electrode and the second electrode during charge and discharge of the electrochemical cell.

The first electrode contains the above-described oxy-nitride electrode active material, and the second electrode contains a suitable counter electrode active materials (preferably a carbon intercalation material). The first and second electrodes each further include an electrically conductive current collector for providing electrical communication between the electrodes and an external load. An electrode film is formed on at least one side of each current collector, preferably both sides of the positive electrode current collector.

### BRIEF DESCRIPTION OF THE DRAWINGS

FIG. 1 is a schematic cross-sectional diagram illustrating the structure of a non-aqueous electrolyte cylindrical electrochemical cell of the present invention.

FIG. 2 is a plot of cathode specific capacity vs. cell voltage for the Li/1M LiPF₆(EC/DMC)/Na₂Fe₂P₃[O₉,N] cell.

FIG. 3 is a first cycle EVS results for a Li/1M LiPF₆ (EC/DMC)/Na₃VP₃[O₉,N] cell.

FIG. 4 is an EVS differential capacity plot based on FIG. 3.

### DETAILED DESCRIPTION OF THE PREFERRED EMBODIMENTS

It has been found that the novel electrochemical cells of this invention afford benefits over such materials and devices among those known in the art. Such benefits include, without limitation, one or more of increased capacity, enhanced cycling capability, enhanced reversibility, enhanced ionic conductivity, enhanced electrical conductivity, enhanced rate capability, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

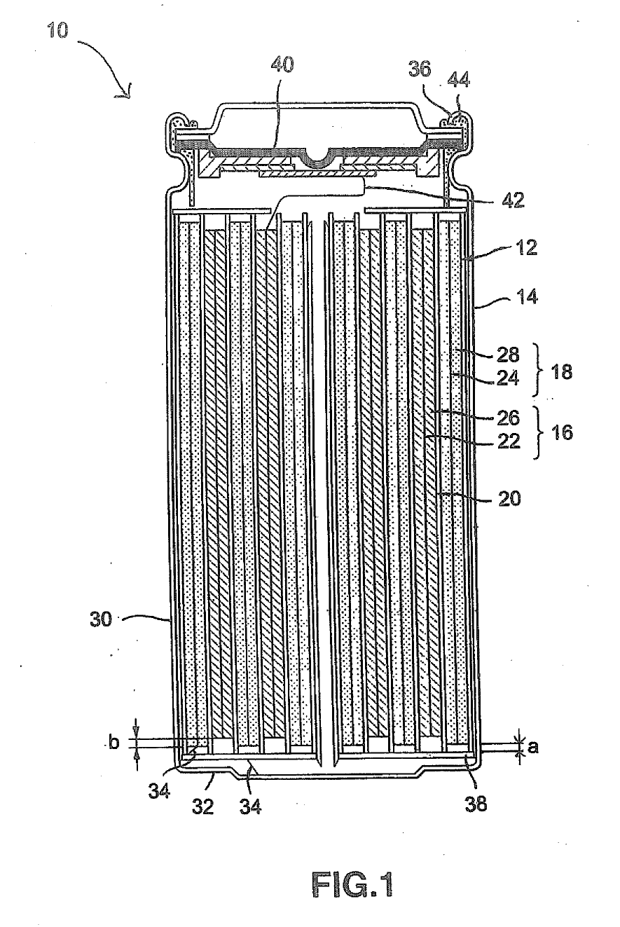

Referring to FIG. 1, one embodiment of a secondary electrochemical cell 10 having a positive electrode active material described herein below as general formula (1), is illustrated. The cell 10 includes a spirally coiled or wound electrode assembly 12 enclosed in a sealed container, preferably a rigid cylindrical casing 14. The electrode assembly 12 includes: a positive electrode 16 consisting of, among other things, an electrode active material described herein below; a counter negative electrode 18; and a separator 20 interposed between the first and second electrodes 16,18. The separator 20 is preferably an electrically insulating, ionically conductive microporous film, and composed of a polymeric material selected from the group consisting of polyethylene, polyethylene oxide, polyacrylonitrile and polyvinylidene fluoride, polymethyl methacrylate, polysiloxane, copolymers thereof, and admixtures thereof.

Each electrode 16,18 includes a current collector 22 and 24, respectively, for providing electrical communication between the electrodes 16,18 and an external load. Each current collector 22,24 is a foil or grid of an electrically conductive metal such as iron, copper, aluminum, titanium, nickel, stainless steel, or the like, having a thickness of between 5 μm and 100 μm, preferably 5 μm and 20 μm. In one embodiment, each current collector is a foil or grid of aluminum.

Optionally, the current collector may be treated with an oxide-removing agent such as a mild acid and the like, and coated with an electrically conductive coating for inhibiting the formation of electrically insulating oxides on the surface of the current collector 22,24. Examples of suitable coatings include polymeric materials comprising a homogenously dispersed electrically conductive material (e.g. carbon), such polymeric materials including: acrylics including acrylic acid and methacrylic acids and esters, including poly (ethylene-co-acrylic acid); vinylic materials including poly(vinyl acetate) and poly(vinylidene fluoride-co-hexafluoropropylene); polyesters including poly(adipic acid-co-ethylene glycol); polyurethanes; fluoroelastomers; and mixtures thereof.

The positive electrode 16 further includes a positive electrode film 26 formed on at least one side of the positive electrode current collector 22, preferably both sides of the positive electrode current collector 22, each film 26 having a thickness of between 10 μm and 150 μm, preferably between 25 μm an 125 μm, in order to realize the optimal capacity for the cell 10. The positive electrode film 26 is preferably composed of between 80% and 99% by weight of a positive electrode active materials described herein below by general formula (1), between 1% and 10% by weight binder, and between 1% and 10% by weight electrically conductive agent.

Suitable binders include: polyacrylic acid; carboxymethylcellulose; diacetylcellulose; hydroxypropylcellulose; polyethylene; polypropylene; ethylene-propylene-diene copolymer; polytetrafluoroethylene; polyvinylidene fluoride; styrene-butadiene rubber; tetrafluoroethylene-hexafluoropropylene copolymer; polyvinyl alcohol; polyvinyl chloride; polyvinyl pyrrolidone; tetrafluoroethylene-perfluoroalkylvinyl ether copolymer; vinylidene fluoride-hexafluoropropylene copolymer; vinylidene fluoride-chlorotrifluoroethylene copolymer; ethylenetetrafluoroethylene copolymer; polychlorotrifluoroethylene; vinylidene fluoride-pentafluoropropylene copolymer; propylene-tetrafluoroethylene copolymer; ethylene-chlorotrifluoroethylene copolymer; vinylidene fluoride-hexafluoropropylene-tetrafluoroethylene copolymer; vinylidene fluoride-perfluoromethylvinyl ether-tetrafluoroethylene copolymer; ethylene-acrylic acid copolymer; ethylene-methacrylic acid copolymer; ethylene-methyl acrylate copolymer; ethylene-methyl methacrylate copolymer; styrene-butadiene rubber; fluorinated rubber; polybutadiene; and admixtures thereof. Of these materials, most preferred are polyvinylidene fluoride and polytetrafluoroethylene.

Suitable electrically conductive agents include: natural graphite (e.g. flaky graphite, and the like); manufactured graphite; carbon blacks such as acetylene black, Ketzen black, channel black, furnace black, lamp black, thermal black, and the like; conductive fibers such as carbon fibers and metallic fibers; metal powders such as carbon fluoride, copper, nickel, and the like; and organic conductive materials such as polyphenylene derivatives.

In one embodiment, the negative electrode is metallic lithium. In another embodiment, the negative electrode 18 is formed of a negative electrode film 28 formed on at least one side of the negative electrode current collector 24, preferably both sides of the negative electrode current collector 24. The negative electrode film 28 is composed of between 80% and 95% of an intercalation material, between 2% and 10% by weight binder, and (optionally) between 1% and 10% by of an weight electrically conductive agent.

Intercalation materials suitable herein include: transition metal oxides, metal chalcogenides, carbons (e.g. graphite), and mixtures thereof capable of intercalating the alkali metal-ions present in the electrolyte in the electrochemical cell's nascent state.

In one embodiment, the intercalation material is selected from the group consisting of crystalline graphite and amorphous graphite, and mixtures thereof, each such graphite having one or more of the following properties: a lattice interplane (002) d-value (d₍₀₀₂₎) obtained by X-ray diffraction of between 3.35 Å to 3.34 Å, inclusive (3.35 Å≦d₍₀₀₂₎≦3.34 Å), preferably 3.354 Å to 3.370 Å, inclusive (3.354 Å≦d₍₀₀₂₎≦3.370 Å; a crystallite size (L_{c}) in the c-axis direction obtained by X-ray diffraction of at least 200 Å, inclusive (L_{c}≧200 Å), preferably between 200 Å and 1,000 Å, inclusive (200 Å≦L_{c}≦1,000 Å); an average particle diameter (P_{d}) of between 1 μm to 30 μm, inclusive (1 μm≦P_{d}≦30 μm); a specific surface (SA) area of between 0.5 m²/g to 50 m²/g, inclusive (0.5 m²/g≦SA≦50 m²/g); and a true density (ρ) of between 1.9 g/cm³to 2.25 g/cm³, inclusive (1.9 g/cm³≦ρ≦2.25 g/cm³).

Referring again to FIG. 1, to ensure that the electrodes 16,18 do not come into electrical contact with one another, in the event the electrodes 16,18 become offset during the winding operation during manufacture, the separator 20 “overhangs” or extends a width “a” beyond each edge of the negative electrode 18. In one embodiment, 50 μm≦a≦2,000 μm. To ensure alkali metal does not plate on the edges of the negative electrode 18 during charging, the negative electrode 18 “overhangs” or extends a width “b” beyond each edge of the positive electrode 16. In one embodiment, 50 μm≦b≦2,000 μm.

The cylindrical casing 14 includes a cylindrical body member 30 having a closed end 32 in electrical communication with the negative electrode 18 via a negative electrode lead 34, and an open end defined by crimped edge 36. In operation, the cylindrical body member 30, and more particularly the closed end 32, is electrically conductive and provides electrical communication between the negative electrode 18 and an external load (not illustrated) An insulating member 38 is interposed between the spirally coiled or wound electrode assembly 12 and the closed end 32.

A positive terminal subassembly 40 in electrical communication with the positive electrode 16 via a positive electrode lead 42 provides electrical communication between the positive electrode 16 and the external load (not illustrated). Preferably, the positive terminal subassembly 40 is adapted to sever electrical communication between the positive electrode 16 and an external load/charging device in the event of an overcharge condition (e.g. by way of positive temperature coefficient (PTC) element), elevated temperature and/or in the event of excess gas generation within the cylindrical casing 14. Suitable positive terminal assemblies 40 are disclosed in U.S. Pat. No. 6,632,572 to Iwaizono, et al., issued Oct. 14, 2003; and U.S. Pat. No. 6,667,132 to Okochi, et al., issued Dec. 23, 2003. A gasket member 42 sealingly engages the upper portion of the cylindrical body member 30 to the positive terminal subassembly 40.

In one embodiment, a non-aqueous electrolyte (not shown) is provided for transferring ionic charge carriers between the positive electrode 16 and the negative electrode 18 during charge and discharge of the electrochemical cell 10. The electrolyte includes a non-aqueous solvent and an alkali metal salt dissolved therein (most preferably, a lithium salt). In the electrochemical cell's nascent state (namely, before the cell undergoes cycling), the non-aqueous electrolyte contains one or more metal-ion charge carriers other than the element(s) selected from composition variable A of general formula (1).

Suitable solvents include: a cyclic carbonate such as ethylene carbonate, propylene carbonate, butylene carbonate or vinylene carbonate; a non-cyclic carbonate such as dimethyl carbonate, diethyl carbonate, ethyl methyl carbonate or dipropyl carbonate; an aliphatic carboxylic acid ester such as methyl formate, methyl acetate, methyl propionate or ethyl propionate; a .gamma.-lactone such as γ-butyrolactone; a non-cyclic ether such as 1,2-dimethoxyethane, 1,2-diethoxyethane or ethoxymethoxyethane; a cyclic ether such as tetrahydrofuran or 2-methyltetrahydrofuran; an organic aprotic solvent such as dimethylsulfoxide, 1,3-dioxolane, formamide, acetamide, dimethylformamide, dioxolane, acetonitrile, propyinitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone; and mixtures thereof. A mixture of a cyclic carbonate and a non-cyclic carbonate or a mixture of a cyclic carbonate, a non-cyclic carbonate and an aliphatic carboxylic acid ester, are preferred.

Suitable alkali metal salts, particularly alkali-metal salts, include: RClO₄; RBF₄; RPF₆; RAlCl₄; RSbF₆; RSCN; RCF₃SO₃; RCF₃CO₂; R(CF₃SO₂)₂; RAsF₆; RN(CF₃SO₂)₂; RB₁₀Cl₁₀; an alkali-metal lower aliphatic carboxylate; RCl; RBr; RI; a chloroboran of an alkali-metal; alkali-metal tetraphenylborate; alkali-metal imides; and mixtures thereof, wherein R is selected from the group consisting of alkali-metals from Group I of the Periodic Table. Preferably, the electrolyte contains at least LiPF₆.

In one embodiment, the positive electrode film 26 contains a positive electrode active material wherein, in the electrochemical cell's nascent state, the charge carrier(s) (e.g. Na) present in the positive electrode active material (as determined by composition variable A of general formula (1)) differs from the charge carrier(s) present in the electrolyte (e.g. Li). As used herein, a “positive electrode active material charge carrier” refers to an element capable of forming a positive ion and undergoing deintercalation (or deinsertion) from the active material upon the first charge of an electrochemical cell containing the same. As used herein, an “electrolyte charge carrier” refers to an ion present in the electrolyte in the electrochemical cell's nascent state. In another embodiment, the positive electrode film 26 contains a positive electrode active material wherein, in the electrochemical cell's nascent state, the charge carrier(s) present in the positive electrode active material are the same as the charge carrier(s) present in the electrolyte.

As noted herein above, for all embodiments described herein, the positive electrode film 26 contains a positive electrode active material represented by the general formula (1):

AₐM_{b}X_{c}[O_{(3c+1)-d},Nₑ] (1)

The electrode active materials described herein are in their nascent or as-synthesized state, prior to undergoing cycling in an electrochemical cell. The components of the electrode active material (e.g. the element(s) comprising stoichiometric variables A, M, X and elements O (oxygen) and N (nitrogen)) and their corresponding stoichiometric variables are selected so as to maintain electroneutrality of the electrode active material in its as-synthesized or nascent state. The stoichiometric values of one or more elements of the composition may take on non-integer values, and are preferably selected so at to satisfy the equation

a+b(V^{M})+c(V^{X})=6c+2−2d+e(V^{N}),

wherein V^{M}, V^{X} and V^{N} are the oxidation states for composition variables M, X and N, respectively, in the electrode active material's as-synthesized or nascent state.

For all embodiments described herein, composition variable A contains at least one element capable of forming a positive ion and undergoing deintercalation from the active material upon charge of an electrochemical cell containing the same In one embodiment, A is selected from the group consisting of elements from Group I of the Periodic Table, and mixtures thereof (e.g. Aₐ=Aₐ₋ₐ,A′_{a′}, wherein A and A′ are each selected from the group consisting of elements from Group I of the Periodic Table and are different from one another, and a′<a). In one subembodiment, in the material's as-synthesized or nascent state, A does not include lithium (Li). In another subembodiment, in the material's as-synthesized or nascent state, A does not include lithium (Li) or sodium (Na).

As referred to herein, “Group” refers to the Group numbers (i.e., columns) of the Periodic Table as defined in the current IUPAC Periodic Table. (See, e.g., U.S. Pat. No. 6,136,472, Barker et al., issued Oct. 24, 2000, incorporated by reference herein.) In addition, the recitation of a genus of elements, materials or other components, from which an individual component or mixture of components can be selected, is intended to include all possible sub-generic combinations of the listed components, and mixtures thereof.

Preferably, a sufficient quantity (a) of composition variable A should be present so as to allow all of the “redox active” elements of composition variable M (as defined herein below) to undergo oxidation/reduction. In one embodiment, 0<a≦6. In another embodiment, 0<a≦3. Removal of an amount (a) of composition variable A from the electrode active material is accompanied by a change in oxidation state of at least one of the “redox active” elements in the active material, as defined herein below. The amount of redox active material available for oxidation/reduction in the active material determines the amount (a) of composition variable A that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

Referring again to general formula (1), in all embodiments described herein, composition variable M includes at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to composition variable M include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. For each embodiment described herein, M may comprise a mixture of oxidation states for the selected element (e.g., M=Mn²⁺Mn⁴⁺). Also, “include,” and its variants, is intended to be non-limiting, such that recitation of items in a list is not to the exclusion of other like items that may also be useful in the materials, compositions, devices, and methods of this invention.

In one embodiment, composition variable M is a redox active element. In one subembodiment, M is a redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, composition variable M includes one or more redox active elements and (optionally) one or more non-redox active elements. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), TI (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M=MIₙMII₀, wherein 0<o+n≦3 and each of o and n is greater than zero (0<o,n), wherein MI and MII are each independently selected from the group consisting of redox active elements and non-redox active elements, wherein at least one of MI and MII is redox active. MI may be partially substituted with MII by isocharge or aliovalent substitution, in equal or unequal stoichiometric amounts.

“Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Li⁺ with Mg²⁺).

For all embodiments described herein where MI is partially substituted by MII by isocharge substitution, MI may be substituted by an equal stoichiometric amount of MII, whereby M=MIₙ₋ₒMIIₒ. Where MI is partially substituted by MII by isocharge substitution and the stoichiometric amount of MI is not equal to the amount of MII, whereby M=MIₙ₋ₒMIIₚ and o≠p, then the stoichiometric amount of one or more of the other components (e.g. A, L and Z) in the active material must be adjusted in order to maintain electroneutrality. For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A, L and Z) in the active material must be adjusted in order to maintain electroneutrality. However, MI may be partially substituted by MII by aliovalent substitution by substituting an “oxidatively” equivalent amount of MII for MI, whereby

$$M = {MI}_{n \frac{o}{{M}^{MI}}} {MII}_{\frac{o}{{V}^{MII}}} ,$$

wherein V^{MI} and V^{MII} are the oxidation states for composition variables MI and MII, respectively, in the electrode active material's as-synthesized or nascent state.

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²+, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and Mil is selected from the group consisting of Zn²⁺, Cd²⁺, and mixtures thereof. In yet another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures thereof.

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is a 3+ oxidation state redox active element selected from the group specified immediately above, and MII is selected from the group consisting of alkali metals, Cu¹⁺, Ag¹⁺ and mixtures thereof.

In another embodiment, M=M1_{q}M2ᵣM3ₛ, wherein:
(i) M1 is a redox active element with a 2+ oxidation state;
(ii) M2 is selected from the group consisting of redox and non-redox active elements with a 1+ oxidation state;
(iii) M3 is selected from the group consisting of redox and non-redox active elements with a 3+ or greater oxidation state; and
(iv) at least one of q, r and s is greater than 0, and at least one of M1, M2, and M3 is redox active.

In one subembodiment, M1 is substituted by an equal amount of M2 and/or M3, whereby q=q−(r+s). In this subembodiment, then the stoichiometric amount of one or more of the other components (e.g. A, L and Z) in the active material must be adjusted in order to maintain electroneutrality. In another subembodiment, M1 is substituted by an “oxidatively” equivalent amount of M2 and/or M3, whereby

$$M = {M1}_{q - \frac{r}{{V}^{M 1}} - \frac{s}{{V}^{M 1}}} M {2}_{- \frac{r}{{V}^{M 2}}} M {3}_{- \frac{s}{M 3}} ,$$

wherein V^{M1} is the oxidation state of M1, V^{M2} is the oxidation state of M2, and V^{M3} is the oxidation state of M3, in the electrode active materials as-synthesized or nascent state.

In one subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺ and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺ and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺, and mixtures thereof; and M3 is selected from the group consisting of Sc³⁺, Y³⁺, B³⁺, Al³⁺, Ga³⁺, In³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In all embodiments described herein, composition variable X is selected from the group consisting of P, As, Sb, Si, Ge, V, S, and mixtures thereof, wherein 2≦c≦5. In one subembodiment, c is 2, 3, 4 or 5.

In one particular embodiment, the positive electrode film 26 contains a positive electrode active material represented by the nominal general formula (2):

AₐM_{b}P₂[O_{7-d},Nₑ], (2)

wherein composition variables A and M and stoichiometric variables a, b, d and e are as described herein above and are selected so as to maintain electroneutrality of the electrode active material in its nascent or as-synthesized state, namely to satisfy the equation a+b(V^{M})=4−2d+3e.

In one subembodiment, e=2/3d and therefore a+b(V^{M})=4. In another subembodiment, e=d and therefore a+b(V^{M})=4+d.

Specific examples of electrode active materials represented by general formula (2) include NaFe₂P₂[O₆,N], NaCo₂P₂[O₆,N], L_{1.1}Fe₂P₂[O_{5.9},N_{1.1}], LiFe_{1.95}Mg_{0.05}P₂[O₆,N], LiFe_{1.90}Ca_{0.1}P₂[O₆,N], Li_{1.2}Ni_{1.90}Ca_{0.1}P₂[O_{5.8},N_{1.2}], Li_{1.1}Ni₂P₂[O_{5.9},N_{0.1}], LiFe_{1.95}Nb_{0.02}P₂[O₆,N], Na₂Fe₂P₂[O₆,N_{2/3}], Na₂Fe₂P₂[O_{6.5},N_{1/3}], Li₂Fe_{1.90}Ca_{0.1}P₂[O₆,N_{2/3}], and Li₂N_{1.90}Co_{0.1}P₂[O_{6.5},N_{1/3}].

In another subembodiment, the positive electrode film 26 contains a positive electrode active material represented by the nominal general formula (3):

A_{1+d}M³⁺P₂[O_{7-d},N_{d}], (3)

wherein composition variables A and M are as described herein above, wherein the element(s) comprising composition variable M has a 3+ oxidation state in the active material's nascent or as-synthesized state, and 0<d≦2, preferably 0<d≦1; and wherein A, M and d are selected so as to maintain electroneutrality of the electrode active material in its nascent or as-synthesized state.

Specific examples of electrode active materials represented by general formula (3) include Li_{2.2}Cr_{0.90}B_{0.1}P₂[O_{5.8},N_{1.2}], Li_{2.1}VP₂[O_{6.9},N_{0.1}], Na₂TiP₂[O₆,N], Na₂VP₂[O₆,N], Li₂Mo_{0.90}Al_{0.1}P₂[O₆,N], Li₂MnP₂[O₆,N], Na_{1.1}MnP₂[O_{6.9},N_{0.1}], and Li₂V_{0.98}Ti_{0.015}P₂[O₆,N].

In another subembodiment, the positive electrode film 26 contains a positive electrode active material represented by the nominal general formula (4):

A_{2+d}M²⁺P₂[O_{7-d},N_{d}], (4)

wherein composition variables A and M are as described herein above, wherein the element(s) comprising composition variable M has a 2+ oxidation state in the active material's nascent or as-synthesized state, and 0<d≦2, preferably 0<d≦1; and wherein A, M and d are selected so as to maintain electroneutrality of the electrode active material in its nascent or as-synthesized state.

Specific examples of electrode active materials represented by general formula (4) include Li_{2.1}NiP₂[O_{6.9},N_{0.1}], Na₃FeP₂[O₆,N], Na₃CoP₂[O₆,N], Li_{3.1}FeP₂[O_{5.9},N_{1.1}], Li₃Fe_{0.95}Mg_{0.05}P₂[O₆,N], Li₃Fe_{0.95}Mo_{0.05}P₂[O₆,N], Li₃Fe_{0.90}Co_{0.1}P₂[O₆,N], Li₃Fe_{0.95}Ni_{0.05}P₂[O₆,N], Li_{3.2}Ni_{0.90}Mg_{0.1}P₂[O_{5.8},N_{1.2}], and Li₃Fe_{0.95}Nb_{0.02}P₂[O₆,N].

In another embodiment, the positive electrode film 26 contains a positive electrode active material represented by the nominal general formula (5):

AₐM_{b}P₃[O_{10-d},Nₑ], (5)

wherein composition variables A and M and stoichiometric variables a, b, d and e are as described herein above and are selected so as to maintain electroneutrality of the electrode active material in its nascent or as-synthesized state, namely to satisfy the equation a+b(V^{M})=5−2d+3e.

In one subembodiment, e=2/3d and a+b(V^{M})=5. In another subembodiment, e=d and a+b(V^{M})=5+d.

Specific examples of electrode active materials represented by general formula (5) include Li₂Fe_{1.95}Mg_{0.05}P₃[O₉,N], Li_{1.1}Co₂P₃[O_{8.9},N_{1.1}], Li_{2.2}Ni_{1.90}Ca_{0.1}P₃[O_{8.8},N_{1.2}], Li_{2.1}Ni₂P₃[O_{8.9},N_{0.1}], Na₂Fe₂P₃[O₉,N], Na₂Co₂P₃[O₉,N], Li₂Co_{1.95}Zn_{0.05}P₃[O₉,N], Li₂Fe_{1.90}Ca_{0.1}P₃[O₉,N], Li₂Fe_{1.95}Nb_{0.02}P₃[O₉,N], Na₃Fe₂P₃[O₉,N_{2/3}], Li₃Ni_{1.90}Co_{0.1}P₃[O_{9.5}, N_{1/3}], Na₃Co₂P₃[O_{9.5},N_{1/3}], and Li₃Fe_{1.90}Mg_{0.1}P₃[O₉,N_{2/3}].

In another subembodiment, the positive electrode film 26 contains a positive electrode active material represented by the nominal general formula (6):

A_{2+d}M³⁺P₃[O_{10-d},N_{d}], (6)

wherein composition variables A and M are as described herein above, wherein the element(s) comprising composition variable M has a 3+ oxidation state in the active material's nascent or as-synthesized state, and 0<d≦2, preferably 0<d≦1; and wherein A, M and d are selected so as to maintain electroneutrality of the electrode active material in its nascent or as-synthesized state.

Specific examples of electrode active materials represented by general formula (6) include Na₃TiP₃[O₉,N], Na₃VP₃[O₉,N], Li₃MnP₃[O₉,N], Li_{3.1}VP₃[O_{8.9},N_{0.1}], Li₃MoP₃[O₉,N], Na₃MoP₃[O₉,N], Li₃CrP₃[O₉,N], Na₃CrP₃[O₉,N], Li₃TiP₃[O₉,N], Na₃TiP₃[O₉,N], Li₃Mo_{0.90}Al_{0.1}P₃[O₉,N], Li_{3.2}Cr_{0.90}B_{0.1}P₃[O_{8.8},N_{1.2}], Na_{2.1}MnP₃[O_{9.9},N_{0.1}], and Li₃V_{0.98}Ti_{0.015}P₃[O₉,N].

In another subembodiment, the positive electrode film 26 contains a positive electrode active material represented by the nominal general formula (7):

A_{1+d}M₂²⁺P₃[O_{10-d},N_{d}], (7)

wherein composition variables A and M are as described herein above, wherein at least one of the element(s) comprising composition variable M has a 2+ oxidation state in the active material's nascent or as-synthesized state, and 0<d≦2, preferably 0<d≦1; and wherein A, M and d are selected so as to maintain electroneutrality of the electrode active material in its nascent or as-synthesized state. In one subembodiment, all of the elements comprising composition variable M have a 2+ oxidation state in the active material's nascent or as-synthesized state.

Specific examples of electrode active materials represented by general formula (7) include Na₂Fe₂P₃[O₉,N], Na₂Co₂P₃[O₉,N], Li₂Cu₂P₃[O₉,N], Na₂Cu₂P₃[O₉,N], Li₂Ni₂P₃[O₉,N], Na₂Ni₂P₃[O₉, N], Li₂Mn₂P₃[O₉,N], Na₂Mn₂P₃[O₉,N], Li_{2.1}Fe₂P₃[O_{8.9},N_{1.1}], Li₂Fe_{1.95}Mg_{0.05}P₃[O₉, N], Li₂Fe_{1.90}Ca_{0.1}P₃[O₉,N], Li_{2.2}Ni_{1.90}Ca_{0.1}P₃[O_{8.8},N_{1.2}], Li₂Fe_{1.90}Co_{0.1}P₃[O₉,N], Li_{1.1}Ni₂P₃[O_{9.9},N_{0.1}], and Li₂Fe_{1.95}Nb_{0.02}P₃[O₉,N].

In one particular embodiment, the positive electrode film 26 contains a positive electrode active material represented by the nominal general formula (8):

AₐM_{b}P₄[O_{13-d},Nₑ], (8)

wherein composition variables A and M and stoichiometric variables a, b, d and e are as described herein above and are selected so as to maintain electroneutrality of the electrode active material in its nascent or as-synthesized state, namely to satisfy the equation a+b(V^{M})=6−2d+3e.

In one subembodiment, e=2/3d and therefore a+b(V^{M})=6. In another subembodiment, e=d and therefore a+b(V^{M})=6+d.

Specific examples of electrode active materials represented by general formula (8) include Li₃Fe_{1.90}Ca_{0.1}P₄[O₁₂,N], Li₃Fe_{1.95}Mg_{0.05}P₄[O₁₂,N], Li_{3.1}Co₂P₄[O_{11.9},N_{1.1}], Li_{3.2}Ni_{1.90}Ca_{0.1}P₄[O_{11.8},N_{1.2}], Li₃Co_{1.95}Zn_{0.05}P₄[O₁₂,N], Na₃Co₂P₄[O₁₂,N], Li_{3.1}Ni₂P₄[O_{11.9},N_{0.1}], Na₃Fe₂P₃[O₁₂,N], Li₃Fe_{1.95}Nb_{0.02}P₄[O₁₂,N], Na₄Fe₂P₄[O₁₂,N_{2/3}], Na₄Co₂P₄[O_{12.5},N_{1/3}], Li₄Ni_{1.90}Co_{0.1}P₄[O_{12.5},N_{1/3}], and Li₄Fe_{1.90}Mg_{0.1}P₄[O₁₂,N_{2/3}].

In one subembodiment, the positive electrode film 26 contains a positive electrode active material represented by the nominal general formula (9):

A_{3+d}M³⁺P₄[O_{13-d},N_{d}], (9)

wherein composition variables A and M are as described herein above, wherein the element(s) comprising composition variable M has a 3+ oxidation state in the active material's nascent or as-synthesized state, and 0<d≦2, preferably 0<d≦1; and wherein A, M and d are selected so as to maintain electroneutrality of the electrode active material in its nascent or as-synthesized state.

Specific examples of electrode active materials represented by general formula (9) include Li_{4.2}Cr_{0.90}B_{0.1}P₄[O_{11.8},N_{1.2}], Na₄TiP₄[O₁₂,N], Na₄VP₄[O₁₂,N], Li_{4.1}VP₄[O_{11.9},N_{1.1}], Li₄Mn_{0.90}Al_{0.1}P₄[O₁₂,N], Li₄MoP₄[O₁₂,N], Na_{3.1}MnP₄[O_{12.9},N_{0.1}], and Li₄V_{0.98}Ti_{0.015}P₄[O₁₂,N].

In another subembodiment, the positive electrode film 26 contains a positive electrode active material represented by the nominal general formula (10):

A_{2+d}M₂²⁺P₄[O_{13-d},N_{d}], (10)

wherein composition variables A and M are as described herein above, wherein the element(s) comprising composition variable M has a 2+ oxidation state in the active material's nascent or as-synthesized state, and 0<d≦2, preferably 0<d≦1; and wherein A, M and d are selected so as to maintain electroneutrality of the electrode active material in its nascent or as-synthesized state.

Specific examples of electrode active materials represented by general formula (10) include Li₃Fe_{1.90}Co_{0.1}P₄[O₁₂,N], Na₃Fe₂P₄[O₁₂,N], Li₃Fe₁₉₀Ca_{0.1}P₄[O₁₂,N], Na₃Co₂P₄[O₁₂,N], Na₃Fe_{1.90}Co_{0.1}P₄[O₁₂,N], Li_{3.1}Fe₂P₄[O_{11.9},N_{1.1}], Li₃Fe_{1.95}Mg_{0.05}P₄[O₁₂,N], Li_{3.2}Ni_{1.90}Ca_{0.1}P₄[O_{11.8},N_{1.2}], Li_{3.1}Ni₂P₄[O_{12.9},N_{0.1}], and Li₃Fe_{1.95}Nb_{0.02}P₄[O₁₂,N].

Active materials of general formulas (1) through (10) are readily synthesized by reacting starting materials in a solid state reaction, with or without simultaneous oxidation or reduction of the metal species involved. Sources of composition variable A include any of a number of salts or ionic compounds of lithium, sodium, potassium, rubidium or cesium. Lithium, sodium, and potassium compounds are preferred. Preferably, the alkali metal source is provided in powder or particulate form. A wide range of such materials is well known in the field of inorganic chemistry. Non-limiting examples include the lithium, sodium, and/or potassium fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germinates, oxides, acetates, oxalates, and the like. Hydrates of the above compounds may also be used, as well as mixtures. In particular, the mixtures may contain more than one alkali metal so that a mixed alkali metal active material will be produced in the reaction.

Sources of composition variable M include salts or compounds of any of the transition metals, alkaline earth metals, or lanthanide metals, as well as of non-transition metals such as aluminum, gallium, indium, thallium, tin, lead, and bismuth. The metal compounds include, without limitation, fluorides, chlorides, bromides, iodides, nitrates, nitrites, sulfates, hydrogen sulfates, sulfites, bisulfites, carbonates, bicarbonates, borates, phosphates, hydrogen ammonium phosphates, dihydrogen ammonium phosphates, silicates, antimonates, arsenates, germanates, oxides, hydroxides, acetates, oxalates, and the like. Hydrates may also be used, as well as mixtures of metals, as with the alkali metals, so that alkali metal mixed metal active materials are produced. The elements or elements comprising composition variable M in the starting material may have any oxidation state, depending the oxidation state required in the desired product and the oxidizing or reducing conditions contemplated, as discussed below. The metal sources are chosen so that at least one metal in the final reaction product is capable of being in an oxidation state higher than it is in the reaction product.

Sources of the X_{c}O_{(3c+1)} moiety are common and readily available. For example, where X is Si, useful sources of silicon include orthosilicates, pyrosilicates, cyclic silicate anions such as (Si₃O₉)⁶⁻, (Si₆O₁₈)¹²⁻ and the like, and pyrocenes represented by the formula [(SiO₃)²⁻]ₙ, for example LiAl(SiO₃)₂. Silica or SiO₂ may also be used. Representative arsenate compounds that may be used to prepare the active materials of the invention wherein X is As include H₃AsO₄ and salts of the anions [H₂AsO₄]⁻ and [HAsO₄]²⁻. Where X is Sb, antimonate can be provided by antimony-containing materials such as Sb₂O₅, M^{I}SbO₃ where M^{I} is a metal having oxidation state 1+, M^{III}SbO₄ where M^{III} is a metal having an oxidation state of 3+, and M^{II}Sb₂O₇ where M^{II} is a metal having an oxidation state of 2+. Additional sources of antimonate include compounds such as Li₃SbO₄, NH₄H₂SbO₄, and other alkali metal and/or ammonium mixed salts of the [SbO₄]³⁻ anion. Where X is S, sulfate compounds that can be used include alkali metal and transition metal sulfates and bisulfates as well as mixed metal sulfates such as (NH₄)₂Fe(SO₄)₂, NH₄Fe(SO₄)₂ and the like. Where X is Ge, a germanium containing compound such as GeO₂ may be used to synthesize the active material. Finally, where X is P, hydrogen ammonium phosphate, dihydrogen ammonium phosphate, and mono-, di- and tri-basic alkali metal hydrogen phosphate may be used to synthesize the active material. Hydrates of any of the above may be used, as can mixtures of the above.

Sources of N include PON (the synthesis of which is described herein below in the Examples), metal nitrides (MN), and alkali ion nitrides such as Li3N and Na3N. When metal or alkali-ion nitrides are employed, the reaction should be performed in an inert, dry atmosphere as these precursors are air/moisture sensitive.

A starting material may provide more than one of composition variables A, M, and X_{c}O_{(3c+1)} and N as is evident in the list above. In various embodiments of the invention, starting materials are provided that combine, for example, composition variable M and X_{c}O_{(3C+1)}, thus requiring only composition variable A and N be added. In one embodiment, a starting material is provided that contains alkali metal, a metal, and phosphate. Combinations of starting materials providing each of the components may also be used. It is preferred to select starting materials with counterions that give rise to volatile by-products. Thus, it is desirable to choose ammonium salts, carbonates, oxides, and the like where possible. Starting materials with these counterions tend to form volatile by-products such as water, ammonia, and carbon dioxide, which can be readily removed from the reaction mixture. This concept is well illustrated in the Examples below.

The sources of composition variables A, M, X_{c}O_{(3c+1)} and N, may be reacted together in the solid state while heating for a time and temperature sufficient to make a reaction product. The starting materials are provided in powder or particulate form. The powders are mixed together with any of a variety of procedures, such as by ball milling without attrition, blending in a mortar and pestle, and the like. Thereafter the mixture of powdered starting materials is compressed into a tablet and/or held together with a binder material to form a closely cohering reaction mixture. The reaction mixture is heated in an oven, generally at a temperature of about 400° C. or greater until a reaction product forms. Exemplary times and temperatures for the reaction are given in the Examples below.

Another means for carrying out the reaction at a lower temperature is hydrothermally. In a hydrothermal reaction, the starting materials are mixed with a small amount of a liquid such as water, and placed in a pressurized bomb. The reaction temperature is limited to that which can be achieved by heating the liquid water in a continued volume creating an increased pressure, and the particular reaction vessel used.

The reaction may be carried out without redox, or if desired under reducing or oxidizing conditions. When the reaction is done without redox, the oxidation state of the metal or mixed metals in the reaction product is the same as in the starting materials. Oxidizing conditions may be provided by running the reaction in air. Thus, oxygen from the air is used to oxidize the starting material containing the transition metal.

The reaction may also be carried out with reduction. For example, the reaction may be carried out in a reducing atmosphere such as hydrogen, ammonia, methane, or a mixture of reducing gases. Alternatively, the reduction may be carried out in-situ by including in the reaction mixture a reductant that will participate in the reaction to reduce the one or more elements comprising composition variable M, but that will produce by-products that will not interfere with the active material when used later in an electrode or an electrochemical cell. One convenient reductant to use to make the active materials of the invention is a reducing carbon. In a preferred embodiment, the reaction is carried out in an inert atmosphere such as argon, nitrogen, or carbon dioxide. Such reducing carbon is conveniently provided by elemental carbon, or by an organic material that can decompose under the reaction conditions to form elemental carbon or a similar carbon containing species that has reducing power. Such organic materials include, without limitation, glycerol, starch, sugars, cokes, and organic polymers which carbonize or pyrolize under the reaction conditions to produce a reducing form of carbon. A preferred source of reducing carbon is elemental carbon.

It is usually easier to provide the reducing agent in stoichiometric excess and remove the excess, if desired, after the reaction. In the case of the reducing gases and the use of reducing carbon such as elemental carbon, any excess reducing agent does not present a problem. In the former case, the gas is volatile and is easily separated from the reaction mixture, while in the latter, the excess carbon in the reaction product does not harm the properties of the active material, because carbon is generally added to the active material to form an electrode material for use in the electrochemical cells and batteries of the invention. Conveniently also, the by-products carbon monoxide or carbon dioxide (in the case of carbon) or water (in the case of hydrogen) are readily removed from the reaction mixture.

The carbothermal reduction method of synthesis of mixed metal phosphates has been described in PCT Publication WO01/53198, Barker et al., incorporated by reference herein. The carbothermal method may be used to react starting materials in the presence of reducing carbon to form a variety of products. The carbon functions to reduce a metal ion in the starting material M source. The reducing carbon, for example in the form of elemental carbon powder, is mixed with the other starting materials and heated. For best results, the temperature should be about 400° C. or greater, and up to about 950° C. Higher temperatures may be used, but are usually not required.

Methods of making the electrode active materials described by general formulas (1) through (10) are generally known in the art and described in the literature, and are also described in: WO 01/54212 to Barker et al., published Jul. 26, 2001; International Publication No. WO 98/12761 to Barker et al., published Mar. 26, 1998; WO 00/01024 to Barker et al., published Jan. 6, 2000; WO 00/31812 to Barker et al., published Jun. 2, 2000; WO 00/57505 to Barker et al., published Sep. 28, 2000; WO 02/44084 to Barker et al., published Jun. 6, 2002; WO 03/085757 to Saidi et al., published Oct. 16, 2003; WO 03/085771 to Saidi et al., published Oct. 16, 2003; WO 03/088383 to Saidi et al., published Oct. 23, 2003; U.S. Pat. No. 6,528,033 to Barker et al., issued Mar. 4, 2003; U.S. Pat. No. 6,387,568 to Barker et al., issued May 14, 2002; U.S. Publication No. 2003/0027049 to Barker et al., published Feb. 2, 2003; U.S. Publication No. 2002/0192553 to Barker et al., published Dec. 19, 2002; U.S. Publication No. 2003/0170542 to Barker at al., published Sep. 11, 2003; and U.S. Publication No. 2003/1029492 to Barker et al., published Jul. 10, 2003; the teachings of all of which are incorporated herein by reference.

The following non-limiting examples illustrate the compositions and methods of the present invention.

### EXAMPLE 1

An electrode active material of formula Li₂Co₂P₃[O₉,N], representative of the general formula A_{1+d}M₂²+P₃[O_{10-d},N_{d}], is made as follows. First, a PON precursor is made according to the following reaction scheme.

C₃H₆N₆+(NH₄)H₂PO₄→PON

To make PON, 6.30 g C₃H₆N₆ (commonly referred to as melamine, (NCNH₂)₃) and 5.75 g of (NH₄)H₂PO₄ are premixed, pelletized, placed in an oven and heated in air at a rate of 2° C./min to an ultimate temperature of 750° C. The temperature is maintained for 1 hour, after which the sample is cooled to room temperature and removed from the oven. Urea, (NH₂)₂CO can also be used in place of C₃H₆N₆, in appropriate stoichiometric amounts, in order to produce the PON precursor.

Li₂Co₂P₃[O₉,N] is then made from the PON precursor. The material is made according to the following reaction scheme.

1 PON+2 LiH₂PO₄+2 CoO→Li₂Co₂P₃[O₉,N]

To make the Li₂Co₂P₃[O₉,N] active material, 0.61 g PON, 2.08 g LiH₂PO₄ and 1.5 g of CoO are premixed, pelletized, placed in an oven and heated in a flowing argon atmosphere at a rate of 2° C./min to an ultimate temperature of 750° C. The temperature is maintained for 8 hours, after which the sample is cooled to room temperature and removed from the oven.

### EXAMPLE 2

An electrode active material of formula Li₃VP₃[O₉,N], representative of the formula Li_{2+d}M³⁺P₃[O_{10-d},N_{d}], is made as follows. First, a PON precursor is made according the teachings of Example 1. Next, V₂O₃ is jet milled to achieve a very finely dispersed powder which gives good reactivity. Li₃VP₃[O₉,N] is then made using the PON and jet milled V₂O₃ precursors according to the following reaction scheme.

PON+2 LiH₂PO₄+0.5 V₂O₃+0.5 Li₂CO₃→Li₃VP₃[O₉,N]

To make the Li₃VP₃[O₉,N] active material, 0.61 g PON, 2.08 g LiH₂PO₄, 0.37 g LiCO₃ and 0.75 g of V₂O₃ are premixed, pelletized, placed in an oven and heated in a flowing argon atmosphere at a rate of 2° C./min to an ultimate temperature of 750° C. The temperature is maintained for 8 hours, after which the sample is cooled to room temperature and removed from the oven.

### EXAMPLE 3

An electrode active material of formula Na₂CO₂P₃[O₉,N], representative of the general formula Na_{1+d}M₂²⁺P₃[O_{10-d},N_{d}], is made as follows. First, a PON precursor is made according the teachings of Example 1. Na₂Co₂P₃[O₉,N] is then made using the PON precursor according to the following reaction scheme.

PON+2 NaH₂PO₄+2 CoO→Na₂Co₂P₃[O₉,N]

To make the Na₂Co₂P₃[O₉,N] active material, 0.61 g PON, 2.40 g LiH₂PO₄, and 1.5 g of CoO are premixed, pelletized, placed in an oven and heated in a flowing argon atmosphere at a rate of 2° C./min to an ultimate temperature of 750° C. The temperature is maintained for 8 hours, after which the sample is cooled to room temperature and removed from the oven,

### EXAMPLE 4

An electrode active material of formula Na₂Fe₂P₃[O₉,N], representative of the general formula Na_{1+d}M₂²⁺P₃[O_{10-d},N_{d}], is made as follows. First, a PON precursor is made according the teachings of Example 1. Na₂Fe₂P₃[O₉,N] is then made using the PON precursor according to the following reaction scheme.

PON+2 NaH₂PO₄+C+Fe₂O₃→Na₂Fe₂P₃[O₉,N]

To make the Na₂Fe₂P₃[O₉,N] active material, 0.61 g PON, 2.40 g LiH₂PO₄, 1.60 g Fe₂O₃ and 0.24 g Ensaco carbon (a 100% excess) are premixed, pelletized, placed in an oven and heated in a flowing argon atmosphere at a rate of 2° C./min to an ultimate temperature of 750° C. The temperature is maintained for 8 hours, after which the sample is cooled to room temperature and removed from the oven.

### EXAMPLE 5

An electrode was made with ˜84% Na₂Fe₂P₃[O₉,N] active material synthesized per Example 4 (11.8 mg), 5% of Super P conductive carbon, and 11% PVdF (Kynar) binder. A cell with that electrode as cathode and a lithium-metal counter electrode was constructed with an electrolyte comprising 1M LiPF₆ solution in ethylene carbonate/dimethyl carbonate (2:1 by weight) while a dried glass fiber filter (Whatman, Grade GF/A) was used as electrode separator.

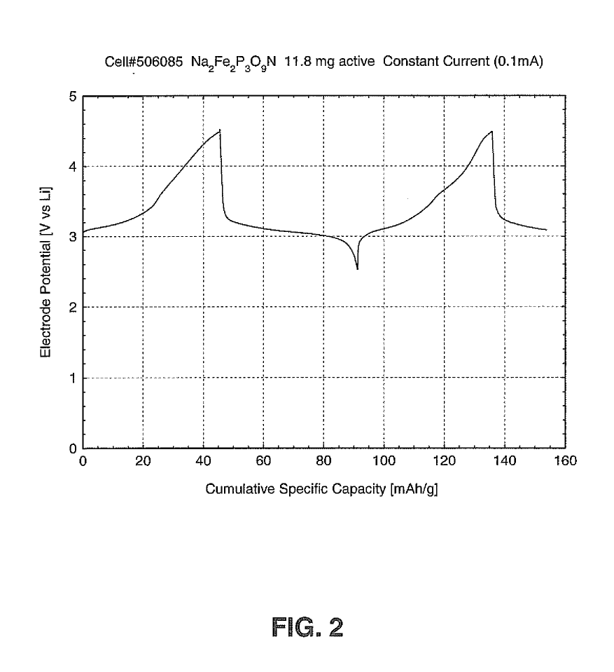

FIG. 2 is a plot of cathode specific capacity vs. cell voltage for the Li/1M LiPF₆ (EC/DMC)/Na₂Fe₂P₃[O₉,N] cell. The cell was cycled using constant current cycling at 0.1 milliamps per square centimeter (mA/cm²) in a range of 2.6 to 4.4 volts (V) at ambient temperature (˜23(C). The initial measured open circuit voltage (OCV) was approximately 3 V vs. Li. The cathode material exhibited a 45 mA·h/g (milliamp-hour per gram) first charge capacity, and a 45 mA·h/g discharge capacity.

### EXAMPLE 6

An electrode active material of formula Na₃VP₃[O₉,N], representative of the general formula Na_{2+d}M³⁺P₃[O_{10-d},N_{d}], is made as follows. First, a PON precursor is made according the teachings of Example 1. Next, V₂O₃ is jet milled to achieve a very finely dispersed powder which gives good reactivity Na₃VP₃[O₉,N] is then made using the PON and jet milled V₂O₃ precursors according to the following reaction scheme.

PON+NaH₂PO₄+0.5 V₂O₃+Na₂HPO₄→Na₃VP₃[O₉,N]

To make the Na₃VP₃[O₉,N] active material, 0.61 g PON, 1.20 g NaH₂PO₄, 1.42 g Na₂HPO₄and 0.75 g of V₂O₃ are premixed, pelletized, placed in an oven and heated in a flowing argon atmosphere at a rate of 2° C./min to an ultimate temperature of 750° C. The temperature is maintained for 8 hours, after which the sample is cooled to room temperature and removed from the oven.

### EXAMPLE 7

An electrode was made with ˜84% Na₃VP₃[O₉,N] active material synthesized per the teachings of Example 6 (11.5 mg), 5% of Super P conductive carbon, and 11% PVdF (Kynar) binder. A cell with that electrode as cathode and a lithium-metal counter electroderbon, and 11% PVdF (Kynar) binder. A cell with that electrode as cathode and a lithium-metal counter electrode was constructed with an electrolyte comprising 1M LiPF₆ solution in ethylene carbonate/dimethyl carbonate (2:1 by weight) while a dried glass fiber filter (Whatman, Grade GF/A) was used as electrode separator.

High-resolution electrochemical measurements were performed using the Electrochemical Voltage Spectroscopy (EVS) technique. EVS is a voltage step method, which provides a high-resolution approximation to the open circuit voltage curve for the electrochemical system under investigation. Such technique is known in the art as described by J. Barker in Synth. Met 28, D217 (1989); Synth. Met. 32, 43 (1989); J. Power Sources, 52, 185 (1994); and Electrochemica Acta, Vol. 40, No. 11, at 1603 (1995).

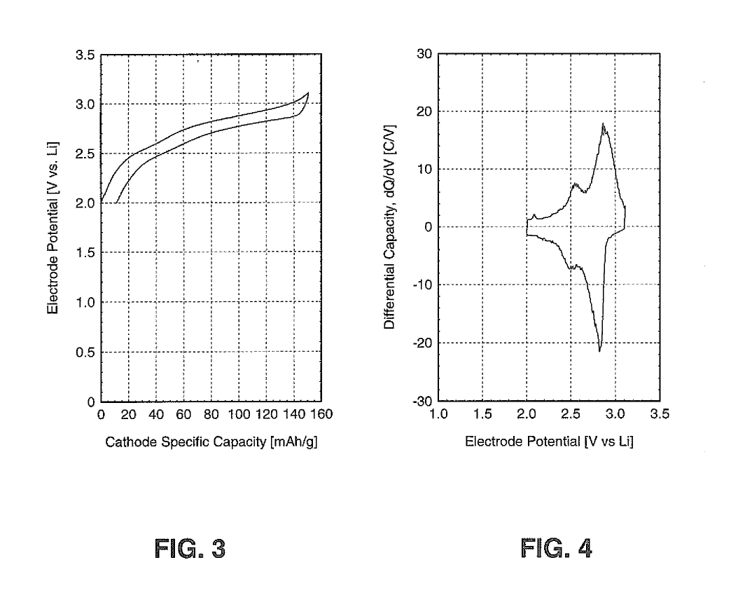

FIGS. 3 and 4 show the voltage profile and differential capacity plots for the first cycle EVS response for the Li/1 M LiPF₆ (EC/DMC)/Na₃VP₃[O₉,N] cell (voltage range: 3-4.6 V vs. Li; Critical current density: 0.1 mA/cm²; voltage step=10 mV). The testing was carried out at ambient temperature (˜23° C.). The initial measured open circuit voltage (OCV) was approximately 3 V. The Na₃VP₃[O₉,N] material exhibited a 153 mA·h/g lithium extraction capacity, and a 142 mA·h/g lithium insertion capacity capacity. The titanate anode material exhibited a 82 mA·h/g first charge capacity, and a 69 mA·h/g first discharge capacity.

### EXAMPLE 8

An electrode active material of formula Li₃VP₃[O₉,N], representative of the general formula Li_{2+d}M³⁺P₃[O_{10-d},N_{d}], is made as follows.

3.0 LiH₂PO₄+0.5 V₂O₃→Li₃VP₃[O₉,N]

To make the Li₃VP₃[O₉,N] active material, 3.12 g of LiH₂PO₄ and 0.75 g of V₂O₃ are premixed, pelletized, placed in an oven and heated in a flowing NH₃ atmosphere at a rate of 2° C./min to an ultimate temperature of 700-800° C. The temperature is maintained for 8 hours, after which the sample is cooled to room temperature and removed from the oven.

### EXAMPLE 9

An electrode active material of formula Li₃VP₃[O₉,N], representative of the general formula Li_{2+d}M³⁺P₃[O_{10-d},N_{d}], is made as follows.

3.0 LiH₂PO₄+VN→Li₃VP₃[O₉,N]

To make the Li₃VP₃[O₉,N] active material, 3.12 g of LiH₂PO₄ and 0.65 g of VN are premixed, pelletized, placed in an oven and heated in a flowing argon or nitrogen atmosphere at a rate of 2° C./min to an ultimate temperature of 700-800° C. The temperature is maintained for 8 hours, after which the sample is cooled to room temperature and removed from the oven.

### EXAMPLE 10

An electrode active material of formula Li₃VP₃[O₉,N], representative of the general formula Li_{2+d}M³⁺P₃[O_{10-d},N_{d}], is made as follows. First, a PON precursor is made according the teachings of Example 1. Li₃VP₃[O₉,N] is then made using the PON precursor according to the following reaction scheme.

Li₃PO₄+VPO₄+PON→Li₃VP₃[O₉,N]

To make the Li₃VP₃[O₉,N] active material, 1.46 g of VPO₄, 0.61 g of PON and 1.16 g of Li₃PO₄ are premixed, pelletized, placed in an oven and heated in a flowing argon or nitrogen atmosphere at a rate of 2° C./min to an ultimate temperature of 700-800° C. The temperature is maintained for 8 hours, after which the sample is cooled to room temperature and removed from the oven.

### EXAMPLE 11

An electrode active material of formula Li_{2.1}NiP₂[O_{6.9}N_{0.1}], representative of the general formula A_{2+d}M²⁺P₂[O_{7-d},N_{d}], is made as follows.

2.0 LiH₂PO₄+NiO+0.05 Li₂CO₃→Li_{2.1}NiP₂[O_{6.9}N_{0.1}]

To make the Li_{2.1}NiP₂[O_{6.9}N_{0.1}] active material, 2.08 g of LiH₂PO₄, 0.75 g of NiO and 0.037 g of Li₂CO₃ are premixed, pelletized, placed in an oven and heated in a flowing NH₃ atmosphere at a rate of 2° C./min to an ultimate temperature of 700-800° C. The temperature is maintained for 8 hours, after which the sample is cooled to room temperature and removed from the oven.

### EXAMPLE 12

An electrode active material of formula Li₂Fe_{1.95}Nb_{0.02}P₃[O₉,N], representative of the general formula AₐM_{b}P₃[O_{10-d},Nₑ], is made as follows. First, a PON precursor is made according the teachings of Example 1. Li₂Fe_{1.95}Nb_{0.02}P₃[O₉,N] is then made using the PON precursor according to the following reaction scheme.

2.0 LiH₂PO₄+0.975 Fe₂O₃+0.01 Nb₂O₅+PON+0.975 C→Li₂Fe_{1.95}Nb_{0.02}P₃[O₉N]

To make the Li₂Fe_{1.95}Nb_{0.02}P₃[O₉N] active material, 2.08 g of LiH₂PO₄, 1.56 g of Fe₂O₃, 0.027 g of Nb₂O₅, 0.61 g of PON and 0.12 g of carbon are premixed, pelletized, placed in an oven and heated in a flowing argon or nitrogen atmosphere at a rate of 2° C./min to an ultimate temperature of 700-800° C. The temperature is maintained for 8 hours, after which the sample is cooled to room temperature and removed from the oven.

### EXAMPLE 13

An electrode active material of formula Na₃Co₂P₄[O₁₂,N], representative of the general formula A_{2+d}M₂²⁺P₄[O_{13-d},N_{d}], is made as follows. First, a PON precursor is made according the teachings of Example 1. Na₃Co₂P₄[O₁₂,N] is then made using the PON precursor according to the following reaction scheme.

3 NaH₂PO₄+2 CoO+PON→Na₃Co₂P₄[O₁₂,N]

To make the Na₃CO₂P₄[O₁₂,N] active material, 3.60 g of NaH₂PO₄, 1.50 g of CoO and 0.61 g of PON are premixed, pelletized, placed in an oven and heated in a flowing argon or nitrogen atmosphere at a rate of 2° C./min to an ultimate temperature of 700-800° C. The temperature is maintained for 8 hours, after which the sample is cooled to room temperature and removed from the oven.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

1. An electrochemical cell, comprising:
a first electrode comprising an electrode active material represented by the general formula:
AₐM_{b}X_{c}[O_{(3c+1)-d},Nₑ]
wherein:
(a) A is at least one alkali metal, and 0<a≦6;
(b) M is at least one redox active element, wherein 1<b≦4;
(c) X is selected from the group consisting of P, As, Sb, Si, Ge, V, S, and mixtures thereof;
(d) 2≦c≦5, 0<d≦(3c+1), and 0<e≦d; and
(e) A, M, X, a, b, c, d and e are selected so as to maintain electroneutrality of the material in its nascent or “as-synthesized” state;
a second electrode; and
an electrolyte for transferring ionic charge carriers between the first electrode and the second electrode.

2. The electrochemical cell according to claim 1, wherein the electrode active material is represented by the general formula AₐM_{b}P₂[O_{7-d},Nₑ].

3. The electrochemical cell according to claim 2, wherein the electrode active material is represented by the general formula A_{1+d}M³⁺P₂[O_{7-d},N_{d}].

4. The electrochemical cell according to claim 3, wherein M comprises an element selected from the group consisting of Ti³⁺, V³⁺, Cr³⁺, Mn³⁺, Fe³⁺, Co³⁺, Ni³⁺, Mo³⁺ and N³⁺.

5. The electrochemical cell according to claim 2, wherein the electrode active material is represented by the general formula A_{2+d}M²⁺P₂[O_{7-d},N_{d}].

6. The electrochemical cell according to claim 5, wherein M comprises an element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺ and Pb²⁺.

7. The electrochemical cell according to claim 1, wherein the electrode active material is represented by the general formula AₐM_{b}P₃[O_{10-d},Nₑ].

8. The electrochemical cell according to claim 77 wherein the electrode active material is represented by the general formula A_{2+d}M³⁺P₃[O_{10-d},N_{d}].

9. The electrochemical cell according to claim 8, wherein M comprises an element selected from the group consisting of Ti³⁺, V³⁺, Cr³⁺, Mn³⁺, Fe³⁺, Co³⁺, Ni³⁺, Mo³⁺ and Nb³⁺.

10. The electrochemical cell according to claim 7, wherein the electrode active material is represented by the general formula A_{1+d}M₂²⁺P₃[O_{10-d},N_{d}].

11. The electrochemical cell according to claim 10, wherein M comprises an element selected from the group consisting of Ti²⁺, V²⁺, Cr²⁺, Mn²⁺, Fe²⁺, Co²⁺, N²⁺, Cu²⁺, Mo²⁺, Si²⁺ Sn²⁺ and Pb²⁺.

12. The electrochemical cell according to claim 1, wherein the electrode active material is represented by the general formula AₙM_{b}P₄[O_{13-d},Nₑ].

13. The electrochemical cell according to claim 12, wherein the electrode active material is represented by the general formula A_{3+d}M³⁺P₄[O_{13-d},N_{d}].

14. The electrochemical cell according to claim 13, wherein M comprises an element selected from the group consisting of Ti³⁺, V³⁺, Cr³⁺, Mn³⁺, Fe³⁺, Co³⁺, Ni³⁺, Mo³⁺ and Nb³⁺.

15. The electrochemical cell according to claim 12, wherein the electrode active material is represented by the general formula A_{2+d}M₂²⁺P₄[O_{13-d},N_{d}].

16. The electrochemical cell according to claim 15, wherein M comprises an element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺ and Pb²⁺.

17. The electrochemical cell according to claim 1, wherein the electrode active material comprises an electrode active material charge-carrier and wherein the electrolyte comprises an electrolyte charge-carrier;
wherein in the electrochemical cell's nascent state the electrolyte charge carrier differs from the electrode active material charge-carrier.

18. The electrochemical cell according to claim 17, wherein in the electrochemical cell's nascent state, the electrolyte charge carrier is Li and A is Na.

19. The electrochemical cell according to claim 17, wherein in the electrochemical cell's nascent state, the electrolyte charge carrier is Na and A is Li.

20. The electrochemical cell according to claim 1 where in the second electrode comprises an intercalation active material.

21. The electrochemical cell according to claim 20, wherein the intercalation active material is selected from the group consisting of transition metal oxides, metal chalcogenides, carbon materials, and mixtures thereof.

22. The electrochemical cell according to claim 21, wherein the intercalation active material is a carbon material.
